(19) United States
(12) Patent Application Publication
(10) Pub. No.: US 2002/0132104 A1
(43) Pub. Date: Sep. 19, 2002

(54) Prepreg, and laminate and printed wiring board featuring same

(76) Inventors: Akira Urakami, Okayama-shi (JP); Makoto Ogawa, Okayama-shi (JP); Kazuhiko Ohaski, Okayama-shi (JP)

Correspondence Address: W. L Gore & Associates, Inc., 551 Paper Mill Road, P.O. Box 9206, Newark, DE, 19714-9206, US

(21) Appl. No.: 09/997,730

(22) Filed: Nov. 28, 2001

(30) Foreign Application Priority Data
Nov. 28, 2000 (JP) 00-361972

(51) Int. Cl. B32B 3/26; B32B 3/06; B32B 5/14

(52) U.S. Cl. 428/308.4; 428/304.4; 428/306.6

(57) ABSTRACT

A prepreg, provided with adhesiveness or fusibility and configured such that voids in a porous polytetrafluoroethylene film are filled with a bromine-free flame-resistant resin composition, wherein this prepreg is such that the bromine content of the resin is 0.09 weight % or less.

### BACKGROUND OF THE INVENTION

The present invention relates to a prepreg featuring a boron-free flame-resistant resin composition, and a laminate and printed wiring board featuring the same.

In conventional practice, resin-covered copper foil is sometimes used as an insulating layer for printed wiring boards, but prepregs are mostly used. Brominated epoxy resins are used for such applications in order to afford desired characteristics, particularly flame resistance. The prepregs are fabricated by impregnating glass cloth, organic fibers, and other substrates with such brominated epoxy resins.

Conventional prepregs based on glass cloth have high dielectric constants, do not lend themselves readily to laser machining, break easily during machining, and possess other drawbacks.

Prepregs (both woven and nonwoven) based on aramid, liquid-crystal polyester fibers, and other organic fibers have large meshes, and hence yield nonuniform fabrics or sheets, develop nonuniformities during laser machining, and possess other drawbacks.

Products obtained by the direct coating of boards with resins are devoid of substrates and require large amounts of phosphorus compounds or inorganic fillers to be used in order to achieve the desired flame resistance by the sole use of resin compositions, resulting in unacceptably low hot moisture resistance and adhesive strength.

In all these cases, adequate flame resistance must be achieved without reducing the characteristics of resins or prepregs below their conventional levels.

In other known prepreg products, porous polytetrafluoroethylene films are used as substrates, and the films are impregnated with a brominated epoxy resin or the like. There is an ever-increasing need for providing prepregs with better flame resistance, heat resistance, moisture resistance, and other reliability attributes. It is also desirable to achieve higher flame resistance without the use of bromine, which is believed to generate noxious gases.

### SUMMARY OF THE INVENTION

The present invention was perfected as a result of the discovery that impregnating an expanded porous polytetrafluoroethylene film with a flame-resistant, bromine-free resin composition can yield a prepreg in which the above-described drawbacks of the prior art can be overcome and excellent heat resistance, moisture resistance, and other characteristics can be afforded in addition to flame resistance by synergy with the expanded porous polytetrafluoroethylene film.

The invention provides a prepreg, comprising expanded porous polytetrafluoroethylene film having voids therein and flame-resistant resin composition disposed in the voids, wherein the bromine content of the resin is 0.09 weight % or less. The flame-resistant resin composition fills the voids of the expanded porous polytetrafluoroethylene film and covers a surface of the expanded porous polytetrafluoroethylene film. The oxygen index of the flame-resistant resin composition is 25 or greater, as defined according to JIS-K-7201. The prepreg has a flame resistance of V-1 or greater when measured by UL 94 flammability testing. The flame-resistant resin composition contains phosphorus in an amount of 10 weight % or less. The porous polytetrafluoroethylene film comprises 5-50 weight % of the prepreg.

The prepreg further comprises an inorganic filler. The inorganic filler is selected from the group consisting of silica, talc, calcium carbonate, titanium white, kaolin clay, bengal, magnesium hydroxide, aluminum hydroxide, calcium hydroxide, dawsonite, calcium aluminate, zinc borate, and glass fibers.

The invention also provides a flame resistant laminate, comprising at least one prepreg as defined above.

The invention also provides a printed wiring board, comprising at least one prepreg as defined above.

### DETAILED DESCRIPTION OF THE INVENTION

The present invention provides a prepreg in which not only flame resistance but also heat resistance, moisture resistance, and other characteristics can be obtained in addition to electrical characteristics (particularly the dielectric constant) by employing a bromine-free, flame-resistant resin composition and using An expanded porous polytetrafluoroethylene film as a substrate.

The bromine-free flame-resistant resin composition used in the present invention should have an oxygen index of 25 or greater, and preferably 28 or greater, as measured in accordance with JIS K 7201.

As used herein, the term “bromine-free” refers to a bromine content of 0.09 weight % or less. The bromine content of the resin composition may, for example, be measured by analyzing the bromine content of the off-gas resulting from incinerating the resin, as specified in JIS-K-0085. The laminate can be evaluated by being analyzed in accordance with JPCA-ES-01-199 (“Method for Testing Halogen-free, Copper-clad Laminates” by Japan Printed Circuit Association).

A prepreg in which the expanded porous polytetrafluoroethylene film is impregnated with a resin composition can be obtained by drying an expanded porous polytetrafluoroethylene film at 70-200° C. after it has been coated and impregnated with such a bromine-free, flame-resistant resin composition. The result is a prepreg whose enhanced flame resistance is complemented by the nonflammability of the expanded porous polytetrafluoroethylene film as such. In particular, the resulting prepreg is thinner and more flame-resistant than a conventional glass cloth prepreg. The expanded porous polytetrafluoroethylene film has another exceptional property as an interlayer insulation material for printed boards, namely, a dielectric constant that is lower than that of other substrates, and is advantageously devoid of the problems described in connection with prepregs in which glass cloth or organic fibers are used as the substrate, or with prepregs obtained by the direct application of resins to boards. These problems include poor laser machinability, formation of nonuniformities during laser machining, and low hot moisture resistance and adhesive strength. Using an expanded porous polytetrafluoroethylene film as the substrate has the additional advantage of providing excellent flexibility and uniformity and making the product easier to handle than glass cloth or organic fibers.

The bromine-free, flame-resistant resin composition of the present invention can be a product obtained by adding flame retardants (phosphorus or nitrogen compounds), inorganic fillers, or the like to resins; a resin or resin composition whose flame resistance is improved without the use of such additives; or a mixture of such resins (compositions) with flame retardants, inorganic fillers, or the like.

The resin composition of the present invention may be obtained by adding a nonhalogen compound (such as a phosphorus or nitrogen compound), an inorganic filler (such as silica or aluminum hydroxide), or another flame retardant. Additional effects may include not only rendering the resin flame resistant but also providing the resin with the characteristics required by a particular application.

Such a flame-resistant resin composition can be obtained by freely combining the main ingredients with curing agents, flame retardants, inorganic fillers, and other components as needed.

As mentioned above, the flame-resistant resin composition of the present invention should have an oxygen index of 25 or greater, and preferably 28 or greater, as measured in accordance with JIS K 7201. Oxygen index is an index indicating flame resistance in terms of the oxygen concentration needed for the continuous combustion of a resin composition, and higher index values indicate better flame resistance.

Examples of main ingredients of the flame-resistant resin include, but are not limited to, cresol novolak epoxy resins, phenol novolak epoxy resins, bisphenol A epoxy resins, bisphenol F epoxy resins, alcohol ether epoxy resins, glycidyl amine epoxy resins, polyimide resins, polycarbonate resins, bismaleimide-triazine resins, silicone resins, melamine resins, urea resins, diallyl phthalate resins, unsaturated polyester resins, nylon resins, and polyester resins. In other words, any bromine-free resin may be used. The main ingredients may be used singly or as an arbitrary combination of multiple ingredients.

The main resin ingredient of the present invention is preferably an epoxy resin primarily containing aromatic groups and existing in the form of a flame-resistant nonhalogen resin composition such as the one described, for example, in JP (Kokai) 2000-219799, 11-279378, or 2000-80251. Using such boron-free, flame-resistant resins as main ingredients makes it possible to reduce the required amount of flame retardants, inorganic fillers, or the like, or to dispense with these additives altogether.

Examples of suitable curing agents include, but are not particularly limited to, 2-methylimidazole, 2-methyl-4-ethylimidazole, 2-phenylimidazole, dimethylaminomethyl phenol, benzyl dimethylamine, methyldianiline, diethyltriamine, dicyandiamide, alkylene amines, and inorganic acid anhydrides. These may be used singly or as an arbitrary mixture of multiple agents.

Examples of suitable flame retardants include nonhalogen flame retardants such as condensation phosphoric acid esters, monomeric phosphoric acid esters, reactive phosphoric acid esters, retardants containing phosphorus derived from inorganic phosphorus systems, retardants containing nitrogen compounds (such as melamine and guanidine), organic compounds (such as expanded graphite), and inorganic fillers such as alumina, talc, calcium carbonate, titanium white, kaolin clay, bengal, magnesium hydroxide, aluminum hydroxide, calcium hydroxide, dawsonite, calcium aluminate, and zinc borate.

When expressed as the proportion of elemental phosphorus in the resin composition, the content of elemental phosphorus should be 10.0 weight % or less, preferably 0.5-6.0 weight %, and ideally 0.5-3.0 weight %. Keeping the content of elemental phosphorus at less than 0.5 weight % is ineffective in terms of flame resistance, whereas keeping this content above 10.0 weight % creates problems in terms of heat resistance, moisture resistance, and other durability attributes.

Inorganic fillers are expected to act not only as flame retardants but also as dimension stabilizers. Measured as a proportion of the resin composition, the packing ratio achieved during the addition of an inorganic filler should be 5.0-70.0 weight %, and particularly 10.060.0 weight %. Setting the packing ratio above 5.0 weight % is not particularly effective in terms of flame resistance or dimensional stability, whereas setting the ratio above 70 weight % reduces the peel strength of copper foil because of inadequate resin content. Silane coupling agents and other surface treatment agents may also be used as such inorganic fillers as long as the essence of the present invention is not compromised.

Besides the flame retardants and inorganic fillers, surfactants and other agents may also be added to the resin during the production of the resin composition in order to improve compatibility between the substrate and the resin, provided the essence of the present invention is not compromised.

The porous polytetrafluoroethylene substrate used in the present invention should preferably comprise an expanded porous polytetrafluoroethylene film with a thickness of 5-500 μm, and preferably 10-300 μm. A thickness less than 5 μm or greater than 500 μm is undesirable because in the fist case problems develop in terms of strength, whereas in the second case it is more difficult to obtain a multilayer printed wiring board.

The substrate film should have a porosity of 10-95 vol %, and preferably 50-85 vol %, in order to provide the voids needed for impregnation with the resin composition. Setting the porosity to less than 10 vol % yields inadequate adhesiveness or fusibility due to resin insufficiency, whereas raising the porosity above 95 vol % creates problems in terms of substrate strength.

In terms of weight, the relation between the substrate and the resin composition should be such that the substrate constitutes 5.0-50.0 weight %, and preferably 20.040.0 weight %, of the entire prepreg. Setting the ratio below 5.0 weight % creates problems in terms of substrate strength, whereas raising the ratio above 50.0 weight % yields inadequate adhesiveness or fusibility due to resin insufficiency.

The prepreg of the present invention can be fabricated by a common method in which the aforementioned resin composition is dissolved to an appropriate concentration in an organic solvent selected in accordance with the object of the present invention from among toluene, xylene, dimethylformamide, dibutyl phthalate, dioctyl phthalate, polyethylene glycol, methyl alcohol, ethyl alcohol, isopropyl alcohol, tetrahydrofuran, acetone, methyl ethyl ketone, 2-ethoxyethanol, and the like; the diluted resin is fashioned into a varnish; and an expanded porous polytetrafluoroethylene substrate is dried after being coated and impregnated with the varnish. Alternatively, it is possible to employ a hot melt impregnation method in which the varnish is rendered less viscous by heating and is then used for impregnation. A product whose substrate is coated on the surface with a resin in addition to being impregnated may also be obtained by reapplying the varnish to a completed prepreg and drying the coated prepreg during the manufacturing process.

The resulting product is a substrate impregnated with a resin composition, or alternatively a substrate coated on the surface with a resin in addition to being impregnated. Advantages of an uncoated product include high thickness accuracy because of reduced resin flow during pressure/heat molding, whereas advantages of a coated product include increased resin flow during pressure/heat molding and increased penetration for the wiring layers.

The prepreg of the present invention has excellent flame resistance, as indicated above. The flame resistance of the prepreg was measured by UL 94 flammability testing (an UL standard) and found to have a rating of V-1 or greater, such as V-1, V-0, or 5V. UL standards are arbitrary standards developed by a private inspection agency, Underwriters Laboratories, Inc. (USA). The US does not have national electrical safety standards, and UL standards and UL marks are considered to be an equivalent of compulsory standards for electrical products and the like. UL 94 flammability testing is carried out to determine whether a material as such is flammable and can spread a flame to the surrounding area when a specimen is ignited with a burner. According to the present invention, the V-1 flame resistance achievable at a thickness of 1/16 inch in the case of a conventional glass cloth substrate could be achieved at a thickness of 1/32 inch when the prepreg of the present invention was used, particularly as applied to the working examples described below. In other words, the prepreg of the present invention has the advantage of offering a wide choice of bromine-free resin compositions because this prepreg is less flammable even when it is thinner than a conventional prepreg with a glass cloth substrate. Thus, flame retardants or inorganic fillers can be used in smaller amounts, offering proportionally wider latitude in terms of varying the physical properties of the resin compositions.

Single- or multi-layer laminates for printed wiring boards or the like can be obtained by employing hot pressing or another commonly known method and using the prepreg of the present invention.

The prepreg of the present invention is primarily used for fabricating printed wiring boards that carry semiconductor devices, and particularly for forming the interlayer insulation of multilayer boards. The prepreg may also be used as a bonding sheet for electronic components or semiconductor chips, and in other applications.

### EXAMPLES

### Working Example 1

A varnish was prepared by mixing the following principal components: 87.43 weight parts of bisphenol A epoxy resin (nonvolatile fraction: 70.0 weight parts), 47.62 weight parts of phenol novolak resin as a curing agent (nonvolatile fraction: 30.0 weight parts), 0.2 weight part of a 10% methyl ethyl ketone solution of 2-ethyl-4-methylimidazole, 25.0 weight parts of addition-type condensation phosphoric acid ester, and 35 weight parts of aluminum hydroxide. Methyl ethyl ketone was added until the nonvolatile content of the varnish became 50%, and the varnish concentration was adjusted. The corresponding phosphorus content was 1.4 weight parts per 100 weight parts of the nonvolatile fraction. An expanded porous polytetrafluoroethylene film (thickness: 50 μm, porosity: 65%, amount: 10 weight parts) was impregnated with 16 weight parts of the nonvolatile varnish fraction and dried for 3 minutes in a 180° C. drier, yielding an uncoated prepreg with a resin content of 64% and a thickness of 50 μm.

The prepreg was laminated 18 times to obtain an evaluation sample, and molded under heating for 120 minutes at a pressure of 20 kgf/m² and a temperature of 180° C., yielding a prepreg laminate with a thickness of 0.8 mm (1/32 inch).

### Working Examples 2 and 3. Comparative Examples 1 and 2

Prepregs were fabricated in the same manner as in Working Example 1 except that the compositions shown in Table 1 were used. Prepreg laminates were also fabricated for evaluation purposes in the same manner as in Working Example 1.

### Comparative Examples 3 and 4

The compositions shown in Table 1 were prepared, and resin boards devoid of substrates were obtained for comparison purposes by poring the varnish into a mold and keeping the mold for 3 hours at 180° C. The resin boards were cut to a thickness of 0.8 mm to create evaluation samples.

### Comparative Example 5

A varnish having the same flame-resistant resin composition as that used in Working Example 1 was applied for impregnation purposes to a glass cloth with a thickness of 0.18 mm, and the impregnated cloth was dried for 10 minutes at 150° C., yielding a prepreg with a thickness of 0.20 mm. The prepreg was laminated four times and molded under heating for 120 minutes at a pressure of 20 kgf/m² and a temperature of 180° C., yielding an evaluation sample in the form of a prepreg laminate with a glass cloth substrate having a thickness of 0.8 mm (1/32 inch).

Evaluation

The laminates and resin boards thus obtained were evaluated by the vertical technique of the UL 94 standard and were additionally evaluated in accordance with JIS K7201, C6481, C6484, and K0085, to measure the following parameters: oxygen index, peel strength of copper foil, dimensional change rate, bromine analysis of off-gas, and dielectric constant.

TABLE 1
Table (In all cases, the weight parts of resins
are indicated in terms of nonvolatile fraction)

| | Working Examples | | | Comparative Examples | | | | |
|---|---|---|---|---|---|---|---|---|
| | 1 | 2 | 3 | 1 | 2 | 3 | 4 | 5 |
| Substrate | PTFE | PTFE | PTFE | PTFE | PTFE | None | None | Glass |
| Resin | | | | | | | | |
| composition | | | | | | | | |
| YD-900-EK80 | 70 | 70 | 70 | | 70 | 70 | 70 | 70 |
| YDB-500- | | | | 70 | | | | |
| KEK80 | | | | | | | | |
| LA-7751 | 30 | 30 | 30 | 30 | 30 | 30 | 30 | 30 |
| 2-Methyl- | 0.2 | 0.2 | 0.2 | 0.2 | 0.2 | 0.2 | 0.2 | 0.2 |
| 4-ethyli- | | | | | | | | |
| midazole | | | | | | | | |
| Condensation | 25 | 60 | | | | 25 | 100 | 25 |
| phosphoric | | | | | | | | |
| acid ester | | | | | | | | |
| (PX-200) | | | | | | | | |
| Aluminum | 35 | | 60 | | | 35 | | 35 |
| hydroxide | | | | | | | | |
| Charac- | | | | | | | | |
| teristics | | | | | | | | |
| Flame | V-0 | V-0 | V-0 | V-0 | X | X | V-0 | V-1 |
| resistance | | | | | | | | |
| (UL 94) | | | | | | | | |
| Oxygen index | 33.1 | 33.6 | 34.0 | 32.1 | 21.0 | 29.3 | 32.5 | 31.1 |
| Dimensional | −0.4 | −0.6 | −0.1 | −0.5 | −0.5 | — | — | −0.1 |
| change rate | | | | | | | | |
| (%) | | | | | | | | |
| Peel strength | 1.5 | 1.0 | 1.3 | 1.4 | 1.4 | — | — | 1.5 |
| of copper | | | | | | | | |
| foil (kN/m) | | | | | | | | |
| PCT test | ◯ | ◯ | ◯ | ◯ | ◯ | ◯ | X | ◯ |
| Bromine | ◯ | ◯ | ◯ | X | ◯ | ◯ | ◯ | ◯ |
| analysis of off- | | | | | | | | |
| gas | | | | | | | | |
| Dielectric | 2.8 | 2.88 | 3.15 | 2.80 | 2.82 | 3.25 | 3.01 | 4.5 |
| constant | | | | | | | | |

Substrate: “PTA” and “glass” correspond to expanded porous polytetrafluoroethylene film and glass cloth, respectively
Dimensional change rate: -....Could not be measured in comparative examples fabricated under special conditions
Peel strength of copper foil: -.....Could not be measured in comparative examples fabricated under special conditions
Flame resistance (UL 94): X.....Outside of grading range (burned readily)
PCT test: Visual test to determine the presence or absence of swelling or other defects after 200 hours at 121° C. and 2 atm (100% humidity)
◯..No swelling or other defects
X...Some swelling
Bromine analysis of off-gas
◯..No bromine-based off-gas detected
X...Some bromine-based off-gas detected
Note: The following resins were used.
YD-900EK80: Bisphenol A epoxy resin from Toto Kasei
YDB-500KEK80: Brominated bisphenol A epoxy resin from Toto Kasei
Phenolite LA-7751: Phenol novolak epoxy resin from Dainippon Ink
Condensation phosphoric acid ester PX-200: manufactured by Daihachi Chemical Industry
Aluminum hydroxide: manufactured by Nippon Light Metal
Glass cloth: WEA18K-107BZ from Nitto Boseki

Merits of the Invention

As is evident from the above description and working examples, the present invention can yield a prepreg that can have sufficiently high flame resistance even without the use of bromine in the resin for impregnating the expanded porous polytetrafluoroethylene film, can in particular exhibit high flame resistance even when thinner than a conventional bromine-free glass cloth prepreg, differs from conventional glass cloth prepregs or the like in its ability to lend itself easily to laser machining, possesses improved electrical characteristics (particularly the dielectric constant), has exceptional heat resistance, moisture resistance, and other physical properties, changes its dimensions only slightly due to the effect of the inorganic filler, and exhibits markedly better characteristics than in the past.

We claim:

1. A prepreg, comprising expanded porous polytetrafluoroethylene film having voids therein and flame-resistant resin composition disposed in said voids, wherein the bromine content of said resin is 0.09 weight % or less.

2. A prepreg as defined in claim 1, wherein the flame-resistant resin composition fills the voids of the expanded porous polytetrafluoroethylene film and covers a surface of the expanded porous polytetrafluoroethylene film.

3. A prepreg as defined in claim 1, wherein an oxygen index of the flame-resistant resin composition is 25 or greater, as defined according to JIS-K-7201.

4. A prepreg as defined in claim 1, wherein said prepreg has a flame resistance of V-1 or greater when measured by UL 94 flammability testing.

5. A prepreg as defined in claim 1, wherein the flame-resistant resin composition contains phosphorus in an amount of 10 weight % or less.

6. A prepreg as defined in claim 1, wherein the porous polytetrafluoroethylene film comprises 5-50 weight % of said prepreg.

7. A prepreg as defined in claim 1 further comprising an inorganic filler.

8. A prepreg as defined in claim 7, wherein the inorganic filler is selected from the group consisting of silica, talc, calcium carbonate, titanium white, kaolin clay, bengal, magnesium hydroxide, aluminum hydroxide, calcium hydroxide, dawsonite, calcium aluminate, zinc borate, and glass fibers.

9. A flame-resistant laminate, comprising at least one prepreg as defined in claim 1.

10. A printed wiring board, comprising at least one prepreg as defined in claim 1.

11. A prepreg, comprising expanded porous polytetrafluoroethylene film having voids therein and flame-resistant resin composition disposed in said voids,
wherein the bromine content of said resin is 0.09 weight % or less,
wherein the flame-resistant resin composition fills the voids of the expanded porous polytetrafluoroethylene film and covers a surface of the expanded porous polytetrafluoroethylene film,
wherein an oxygen index of the flame-resistant resin composition is 25 or greater, as defined according to JIS-K-7201, wherein said prepreg has a flame resistance of V-1 or greater when measured by UL 94 flammability testing,
wherein the flame-resistant resin composition contains phosphorus in an amount of 10 weight % or less,
wherein the porous polytetrafluoroethylene film comprises 5-50 weight % of said prepreg,
further comprising an inorganic filler,
wherein the inorganic filler is selected from the group consisting of silica, talc, calcium carbonate, titanium white, kaolin clay, bengal, magnesium hydroxide, aluminum hydroxide, calcium hydroxide, dawsonite, calcium aluminate, zinc borate, and glass fibers.
